(19) United States
(12) Patent Application Publication
(10) Pub. No.: US 2025/0065962 A1
(43) Pub. Date: Feb. 27, 2025

(54) VIBRATION DAMPING DEVICE, CAB AND COLLABORATIVE OPTIMIZATION METHOD FOR FATIGUE LIFE AND LIGHTWEIGHT OF CAB

(71) Applicant: JIANGSU XCMG STATE KEY LABORATORY TECHNOLOGY CO., LTD., Jiangsu (CN)

(72) Inventors: Xiangyu NI, Jiangsu (CN); Chao ZHUANG, Jiangsu (CN); Yubing XU, Jiangsu (CN); Da ZHANG, Jiangsu (CN)

(73) Assignee: JIANGSU XCMG STATE KEY LABORATORY TECHNOLOGY CO., LTD., Jiangsu (CN)

(21) Appl. No.: 18/723,872

(22) PCT Filed: Dec. 8, 2022
(86) PCT No.: PCT/CN2022/137398

§ 371 Date: Jun. 25, 2024

(30) Foreign Application Priority Data
Dec. 6, 2022 (CN) 202211553046.7

(51) Int. Cl. B62D 33/06; G06F 30/20

(52) U.S. Cl. CPC B62D 33/0604; G06F 30/20

(57) ABSTRACT

The vibration damping device comprises a first vibration damping unit. The first vibration damping unit comprises protective nets, a fixing plate, a base, a guide element, a first elastic element and a limiting element. The fixing plate is arranged opposite to the base and connected to the protective nets. The guide element is located between the fixing plate and the base and opposite to the base. A movement space is formed between the guide element and the base. The base is also configured to be connected to a cab body. The first elastic element is arranged in the movement space. The limiting element has one end connected to the base and the other end working together with the fixing plate to limit the stroke of the first elastic element.

### TECHNICAL FIELD

The invention belongs to the technical field of engineering machinery, and particularly relates to a vibration damping device, a cab and a collaborative optimization method for the fatigue life and lightweight of a cab.

### DESCRIPTION OF RELATED ART

Construction operations of engineering machinery are often accompanied by large impacts and strong vibrations, which cause the floor and seat in a cab to vibrate seriously, deteriorating the comfort of drivers sharply. In the meanwhile, it causes structural cracks at the joints of a framework, thin plate parts and the like, and the problem of vibration fatigue failure is becoming striking. In order to solve the issues about comfort of drivers and vibration fatigue failure, vibration dampers are generally installed at the bottom of the cab to filter out vibrations from the engine and working devices. However, due to their inherent characteristics, the vibration dampers have a poor vibration isolation effect in a low frequency range.

Chinese invention patent application No. 201911280029.9 discloses a cab framework, a cab and an excavator. The cab framework comprises a main framework, a right lower covering part, a right covering part, a front upper covering part, a top covering part, a rear covering part and a left covering part that are assembled by welding. The main framework is configured as a closed structure welded from metal profiles, rectangular pipes and reinforcing ribs, and has a stable and simple structure and high strength. This solution has three common problems: (1) due to the large redundancy in structural design of the cab, the cab has a large weight, a high production cost, and a low cost effect in use. (2) Only the static fatigue life of the structure, rather than the dynamic fatigue life, is considered, easily causing local stress concentration and high risk of cracking failure. (3) Most of the reinforcing ribs are straight plates or bent plates, with a simple structure and a limited reinforcing effect.

Chinese invention patent application No. 202010837510.X discloses a combined dynamic vibration absorber optimization method and system, a terminal device and a storage medium. The combined dynamic vibration absorber optimization method comprises: establishing a combined dynamic vibration absorber model provided with dynamic vibration absorbers of the same number and the same type; under the same optimization constraint condition, simulating and analyzing a main system amplitude-frequency response result according to five combination modes of four parameters including the mass, stiffness, damping, and damping rate of the dynamic vibration absorbers; obtaining an optimal combination mode in the five combination modes on the basis of the principle of minimizing the minimum value of a maximum power amplification coefficient of a main system; obtaining the optimized spring stiffness of each dynamic vibration absorber according to the optimal combination mode; and selecting an optimized dynamic vibration absorber corresponding to the optimized spring stiffness. This solution obtains the optimized stiffness of each vibration absorber based on the principle of minimizing the minimum value of the maximum power amplification coefficient of the main system, and the arrangement of a large-sized vibration absorber or multiple small-sized vibration absorbers will affect the space and weight of the cab. It can be seen that this solution still cannot solve the issues about comfort of drivers and vibration fatigue failure.

Therefore, it is desired urgently to design a novel vibration damping device and arrange it at a reasonable position in a cab to effectively reduce the vibrations of the cab, and to provide a collaborative optimization method for the dynamic fatigue life and lightweight of a cab, by which the fatigue life of the cab reaches the standard and the weight of the cab is optimized.

### SUMMARY OF THE INVENTION

In response to the above problems, the invention provides a vibration damping device, a cab, and a collaborative optimization method for the fatigue life and lightweight of a cab, which can effectively reduce vibrations of the cab and solve the issues about the comfort of drivers and vibration fatigue failure.

In order to achieve the above technical objectives and technical effects, the invention is implemented by the following technical solutions:
In a first aspect, the invention provides a vibration damping device for a cab, comprising a first vibration damping unit, wherein the first vibration damping unit comprises protective nets, a fixing plate, a base, a guide element, a first elastic element and a limiting element;
the fixing plate is arranged opposite to the base and connected to the protective nets;
the guide element is located between the fixing plate and the base and opposite to the base, a movement space is formed between the guide element and the base, and the base is also configured to be connected to a cab body;
the first elastic element is arranged in the movement space;
the limiting element has one end connected to the base and the other end working together with the fixing plate to limit the stroke of the first elastic element.

Optionally, the limiting element comprises a limiting cylinder and a limiting plate; the guide element comprises a guide rod and a guide plate;
the limiting cylinder has one end connected to the base and the other end working together with the fixing plate to limit the stroke of the first elastic element;
the limiting plate is configured as an elastic body and is connected to the fixing plate, and the limiting plate is capable of reciprocating in the limiting cylinder;
the guide plate is arranged opposite to the base, and a movement space is formed between the guide plate and the base;
the guide rod has one end connected to the base and the other end passing through the guide plate, the limiting plate and the fixing plate in sequence; the guide plate, the limiting plate and the fixing plate are capable of reciprocating along the guide rod.

Optionally, the first elastic element is configured as a spiral spring or a rubber spring;
the rubber spring comprises a metal inner ring body, a rubber outer ring body and a rubber boss structure;
the metal inner ring body is in a hollow structure;
the rubber outer ring body is arranged around the metal inner ring body and is connected to the metal inner ring body by means of the rubber boss structure.

Optionally, at one end of the rubber spring, an end portion of the rubber outer ring body is higher than end portions of the rubber boss structure and the metal inner ring body, and the end portion of the metal inner ring body is higher than the end portion of the rubber boss structure; at the other end of the rubber spring, the end portion of the metal inner ring body is higher than the end portions of the rubber outer ring body and the rubber boss structure.

Optionally, the outer diameter of the metal inner ring body is ⅓ to ⅔ of the diameter of the rubber spring, the thickness of the rubber outer ring body is 1/10 to ⅓ of the diameter of the rubber spring, and the diameter of the rubber boss structure is greater than or equal to 1/10 of the diameter of the rubber spring.

Optionally, the first vibration damping unit further comprises a damping element which is a damping rod or a granular damping material; the granular damping material is arranged in a closed space formed between the rubber spring and the guide plate.

Optionally, the first vibration damping unit has a frequency modulation ratio within a range of 0.85 to 0.95.

Optionally, the vibration damping device further comprises a second vibration damping unit; the second vibration damping unit comprises a fixed frame, a combined mass block and a second elastic element;
the combined mass block is installed in the fixed frame and comprises a mass block holder and a plurality of sub-mass blocks connected to the mass block holder; the number and shape of the sub-mass blocks are determined by the frequency of vibrations to be eliminated;
the second elastic element is arranged between the fixed frame and the combined mass block, has stiffness and damping properties, and has two directional degrees of freedom.

Optionally, the second elastic element has a frequency modulation ratio within a range of 0.90 to 0.97.

In a second aspect, the invention provides a cab, comprising the vibration damping device according to any one of solutions in the first aspect.

In a third aspect, the invention provides a collaborative optimization method for the fatigue life and lightweight of a cab, comprising:
using the plate thickness of elements to be optimized, in a cab body, that meet a preset condition as a key design variable;
using the original plate thickness of the elements to be optimized that meet the preset condition before optimization and the minimum plate thickness of elements reaching a fatigue life indicator to determine a feasible region; and
taking the fatigue life of a cab assembly and the total weight of the cab assembly as goals of collaborative optimization and taking properties of the cab assembly after optimization being superior to or equal to those of the cab assembly before optimization as a constraint, performing interpolation within the feasible region to obtain an optimal combination of key design variables, wherein the cab assembly comprises the cab body and the vibration damping device according to any one of claims 1-9.

Optionally, the step of using the elements, in a cab body, that meet a preset condition as a key design variable comprises the following sub-steps:
obtaining preset elements to be optimized;
filtering elements to be optimized of which weight ratios to the total weight of the cab assembly are greater than a set threshold, and classifying elements to be optimized of which plate thickness difference is less than a set threshold into a group to form a plurality of combinations;
based on a finite element mesh model of the cab assembly before optimization, by reducing the plate thickness of the elements to be optimized in one combination, calculating the fatigue life corresponding to each combination under different plate thickness conditions, and further calculating sensitivity of each combination to the fatigue life of the cab assembly; and
deleting combinations having a sensitivity greater than a set threshold, and using the plate thickness of the elements to be optimized in the remaining combinations as a key design variable.

Optionally, the minimum plate thickness of the elements reaching the fatigue life indicator is obtained by the following step:
based on the finite element mesh model of the cab assembly before optimization, carrying out fatigue life simulation calculations to obtain the minimum plate thickness of the elements to be optimized in the remaining combinations when the elements meet the fatigue life requirement.

Optionally, the step of taking the fatigue life of a cab assembly and the total weight of the cab assembly as goals of collaborative optimization and taking properties of the cab assembly after optimization being superior to or equal to those of the cab assembly before optimization as a constraint, performing interpolation within the feasible region to obtain an optimal combination of key design variables comprises the following sub-steps:
taking a number of each combination and the plate thickness of the elements to be optimized in each combination as two-dimensional coordinates of the feasible region, and performing interpolation within the feasible region using a preset interpolation method to obtain a plurality of schemes, wherein each scheme is expressed as: (the number of the combination, the plate thickness of the elements to be optimized in the combination);
carrying out fatigue life simulation calculations for each optimization scheme, and based on results of the fatigue life simulation calculations, filtering combinations that reach the fatigue life indicator, as well as plate thickness corresponding to each of the combinations;
based on the filtered combinations and the plate thickness corresponding to each of the combinations, calculating the total weight of the cab assembly after optimization, and filtering a minimum total weight of the cab assembly; and
if a difference between the minimum total weight of the cab assembly after optimization and a target total weight of the cab assembly is less than a preset value, using the plate thickness corresponding to the filtered combination as an optimal combination.

Optionally, the minimum total weight of the cab assembly is obtained by:

$$min f ( x ) = min \{ {f}_{I} ( x ) , {f}_{II} ( x ) , {f}_{III} ( x ) , {f}_{IV} ( x ) , {f}_{V} ( x ) , … , {f}_{k} ( x ) \} + {f}_{C}$$

$$x = {[ {x}_{I} , {x}_{II} , {x}_{III} , {x}_{IV} , {x}_{V} , … {x}_{k} ]}^{T}$$

where, x is the key design variable, x=[x_{I}, x_{II}, x_{III}, x_{IV}, x_{V}, . . . , xₖ]^{T} is variable space; I, II, III, IV, V . . . are the numbers of the filtered combinations; ƒ(x) is the total weight of the cab assembly after optimization; ƒₖ(x) is the weight of each filtered combination; ƒ_{c} is the remaining value of the total weight of the cab assembly minus the original mass of all the filtered elements to be optimized.

Optionally, prior to the step of taking a number of each combination and the plate thickness of the elements to be optimized in each combination as two-dimensional coordinates of the feasible region, the collaborative optimization method for the fatigue life and lightweight of a cab further comprises:
taking the number of each combination and the plate thickness of the elements to be optimized in each combination as two-dimensional coordinates of the feasible region to calculate the total weight of the cab assembly corresponding to each combination under different plate thickness conditions; and
based on the criteria that the calculated total weight of the cab assembly should be less than the target total weight of the cab assembly, excluding combinations that do not reach the criteria, as well as the plate thickness corresponding to the combinations.

Compared with the prior art, the invention has the following beneficial effects:

The invention provides a first vibration damping unit for absorbing vibrations by means of the protective nets, and also provides a layout relationship (i.e., an installation relationship) among the first vibration damping unit, the protective nets, and the cab. In this way, the first vibration damping unit will not occupy the space of the cab, and low-frequency vibrations transferred from a vibration source to the cab and the driver can be eliminated.

Further, the invention further provides a second vibration damping unit special for a seat to eliminate two-way vibrations, and also provides an optimal layout of vibration absorbers in the cab. In this way, the first vibration damping unit will not occupy the space of the cab body, and the low-frequency vibrations transferred from the vibration source to the cab and the driver can be eliminated.

The invention provides a collaborative optimization method for the fatigue life and lightweight of a cab. By designing the plate thickness of the elements to be optimized in the cab body, the fatigue life of the cab can be ensured and the total weight of the cab is minimized.

### DESCRIPTION OF THE DRAWINGS

In order to make the content of the invention easier to understand clearly, the invention will be further described in detail below according to specific embodiments and in conjunction with the accompanying drawings, in which

FIG. 1 is a three-dimensional structural diagram of a cab assembly of an engineering machine;

FIG. 2 is a three-dimensional structural diagram of a framework of a cab body of an engineering machine;

FIG. 3 is a three-dimensional diagram of a first vibration damping unit that uses a spiral spring as a first elastic element;

FIG. 4 is a cross-sectional diagram of a first vibration damping unit that uses a spiral spring as a first elastic element;

FIG. 5 is a three-dimensional diagram of a first vibration damping unit that uses a rubber spring as a first elastic element;

FIG. 6 is a cross-sectional diagram of a first vibration damping unit that uses a rubber spring as a first elastic element;

FIG. 7 is a three-dimensional diagram of a rubber spring;

FIG. 8 is a three-dimensional diagram of a second vibration damping unit;

FIG. 9 is an exploded diagram of a second vibration damping unit; and

FIG. 10 is a flow chart of a collaborative optimization method;

where:
1. cab assembly, 2. cab body, 3. front lower protective net, 4. front upper protective net, 5. top protective net, 6. first elastic element, 6-1. spiral spring, 6-2. rubber spring, 6-2-1. metal inner ring body, 6-2-2, rubber boss structure, 6-2-3 rubber outer ring body, 7. guide element, 7-1 guide plate, 7-2. guide rod, 8. limiting element, 8-1. limiting cylinder, 8-2. limiting plate, 9. first vibration damping unit, 10. base, 11 fixing plate, 12 second vibration damping unit, 12-1 fixed frame, 12-2 second elastic element, 12-3 combined mass block, 12-3-1. mass block holder, 12-3-2. distributed mass block, 12-4 covering, 13-rear pillar, 14. seat support, 15. rear rectangular tube, 16. front left A-pillar profile, 17. front right A-pillar profile, 18. top left main framework profile, 19-top right main framework profile, 20-top rectangular tube, 21. front bottom plate rectangular tube.

### DETAILED DESCRIPTION OF THE INVENTION

In order to make the objectives, technical solutions and advantages of the invention more comprehensible, the invention will be further described in detail. It should be understood that the specific embodiments described herein are merely illustrative ones of the invention and are not intended to limit the invention.

The application principle of the invention will be further described below in conjunction with the accompanying drawings.

### Embodiment 1

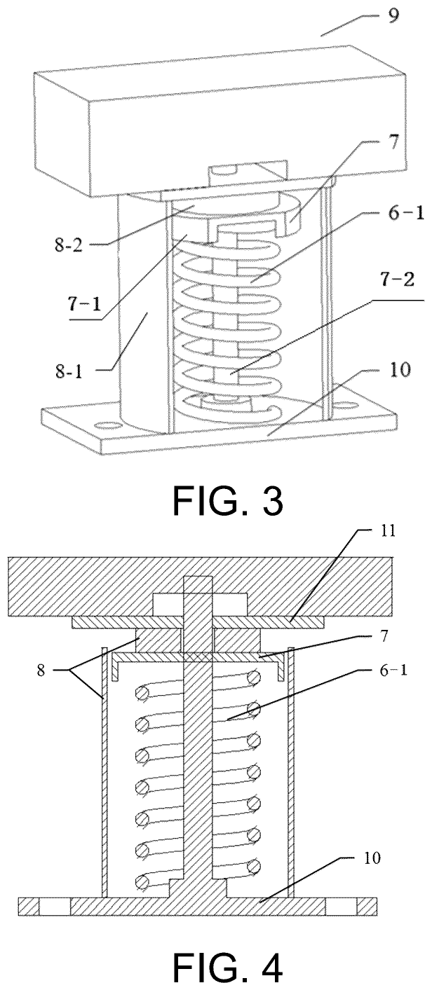

In this embodiment, the invention provides a vibration damping device for a cab, as shown in FIGS. 3-6, comprising a first vibration damping unit 9. The first vibration damping unit 9 comprises protective nets, a guide element 7, a base 10, a first elastic element 6, a limiting element 8, and a fixing plate 11.

The fixing plate 11 is arranged opposite to the base 10 and connected to the protective nets.

The guide element 7 is located between the fixing plate 11 and the base 10 and opposite to the base 10, a movement space is formed between the guide element 7 and the base 10, and the base 10 is also configured to be connected to the cab.

The first elastic element 6 is arranged in the movement space.

The limiting element 8 has one end connected to the base 10 and the other end working together with the fixing plate 11 to limit the stroke of the first elastic element 6.

In this embodiment, the invention provides a first vibration damping unit for absorbing vibrations by means of the protective nets, and also provides that the first vibration damping unit is arranged between the protective net and the cab, that is, a layout relationship among the first vibration damping unit, the protective nets, and the cab is defined. In this way, the first vibration damping unit will not occupy the space of the cab body, and low-frequency vibrations transferred from a vibration source (i.e., an engineer) to the cab body and the driver can be eliminated.

In an implementation of this embodiment of the invention, the first vibration damping unit has a frequency modulation ratio within a range of 0.85 to 0.95. In practice, the frequency modulation ratio of the first vibration damping unit 9 is changed mainly by adjusting the mass of the protective nets, supplemented by adjusting the stiffness parameter of the first elastic element 6.

In an implementation of this embodiment of the invention, the first vibration damping unit 9 is also known as a protective net dynamic vibration absorber; three first vibration damping units 9 may be provided and respectively installed between the cab body 2 and a front lower protective net 3, between the cab body 2 and a front upper protective net 4 and between the cab body 2 and a top protective net 5; the front lower protective net 3, the front upper protective net 4 and the top protective net 5 can move in the direction of single degree of freedom or multiple degrees of freedom, thereby eliminating low-frequency vibrations of the cab in a specified direction.

In an implementation of this embodiment of the invention, the limiting element 8 comprises a limiting cylinder 8-1 and a limiting plate 8-2; the guide element 7 comprises a guide rod 7-2 and a guide plate 7-1.

The limiting cylinder 8-1 has one end connected to the base 10 and the other end working together with the fixing plate 11 to limit the stroke of the first elastic element 6.

Preferably, a distance between the other end of the limiting cylinder 8-1 and the fixing plate 11 is set within a range of 5 mm to 20 mm, that is, the movement stroke of the limiting element 8 is within a range of 5 mm to 20 mm, thereby ensuring that the protective nets can move with a small stroke (such as 5-20 mm) to achieve the function of vibration absorption.

The limiting plate 8-2 is configured as an elastic body and is connected to the fixing plate 11. The limiting plate 8-2 is capable of reciprocating in the limiting cylinder 8-1.

The guide plate 7-1 is arranged opposite to the base 10, and a movement space is formed between the guide plate 7-1 and the base 10.

The guide rod 7-2 has one end connected to the base 10 and the other end passing through the guide plate 7-1, the limiting plate 8-2 and the fixing plate 11 in sequence. The guide plate 7-1, the limiting plate 8-2 and the fixing plate 11 are capable of reciprocating along the guide rod 7-2. In a specific implementation, the base 10 is configured as an internally threaded base, which is threadedly connected to one end of the guide rod 7-2.

When the first vibration damping unit 9 is under pressure or is pressed, the first elastic element 6 and the limiting plate 8-2 are adjusted so that the first elastic element 6 and the limiting plate 8-2 take a vibration absorbing effect within a reasonable range.

The guide element 7 is preferably designed to allow the protective nets to move in the direction of a single degree of freedom, where the front lower protection net 3 and the first vibration damping unit 9 connected thereto are designed to eliminate vibrations of the cab in a running direction, and the top protective net 5 and the first vibration damping unit 9 connected thereto are designed to eliminate vibrations of the cab in a vertical direction.

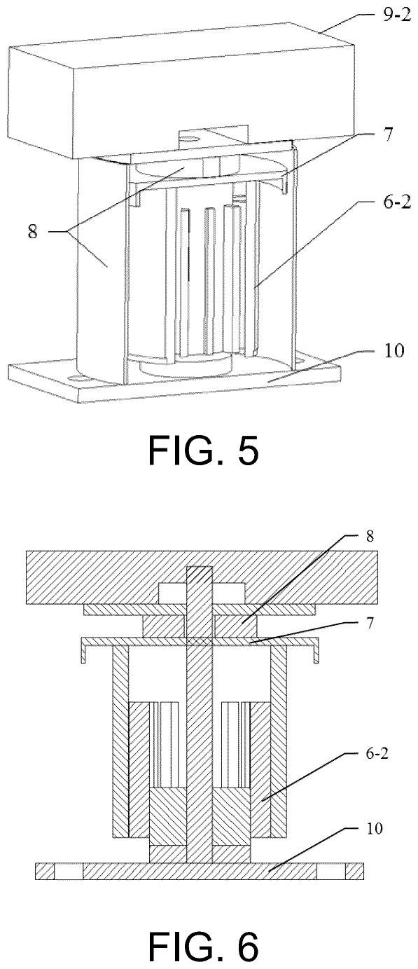

In a specific implementation manner of this embodiment of the present invention, the first elastic element 6 is a spiral spring 6-1 (see FIGS. 3 and 4) or a rubber spring 6-2 (see FIGS. 5 and 6). The rubber spring comprises a metal inner ring body 6-2-1, a rubber outer ring body 6-2-3 and a rubber boss structure 6-2-2.

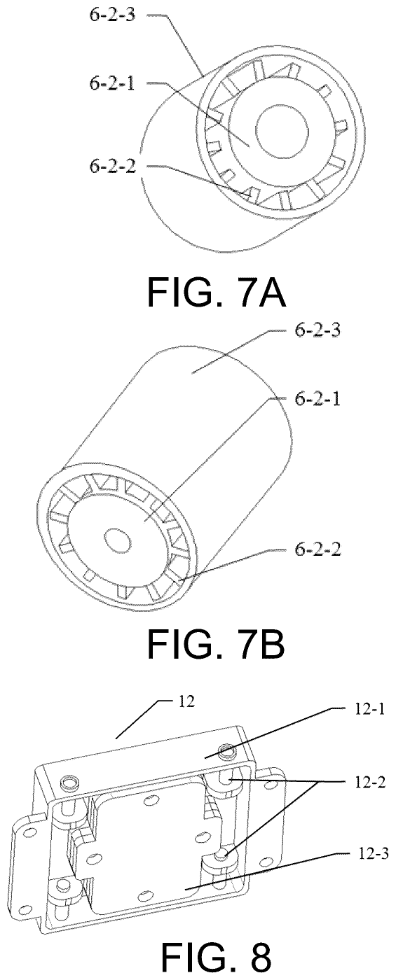

As shown in FIG. 7, the metal inner ring 6-2-1 is a hollow structure, and the hollow structure is configured to receive the guide rod 7-2 in the guide element 7, and the guide rod 7-2 is configured to fix and constrain the rubber spring 6-2.

The rubber outer ring body 6-2-3 is arranged around the metal inner ring body 6-2-1 and is connected to the metal inner ring body 6-2-1 by means of the rubber boss structure 6-2-2. In a specific implementation, the rubber boss structure 6-2-2 and the metal inner ring body 6-2-1 are connected using an adhesive process. In a specific implementation of this embodiment of the invention, the metal inner ring body 6-2-1, the rubber boss structure 6-2-2 and the rubber outer ring body 6-2-3 operate with each other by means of a layer-by-layer step-back design.

Specifically, at one end of the rubber spring 6-2, an end portion of the rubber outer ring body 6-2-3 is higher than end portions of the rubber boss structure 6-2-2 and the metal inner ring body 6-2-1, and the end portion of the metal inner ring body 6-2-1 is higher than the end portion of the rubber boss structure 6-2-2; at the other end of the rubber spring 6-2, the end portion of the metal inner ring body 6-2-1 is higher than the end portions of the rubber outer ring body 6-2-1 and the rubber boss structure 6-2-2. In this way, the variable ranges of the stiffness and damping of the rubber spring 6-2 are widened. In a specific implementation, each first vibration damping unit 9 is generally used in combination with a damping element (not shown in the figure) to achieve the vibration damping function to the greatest extent. The damping element may be a damping rod or a granular damping material; the granular damping material is arranged in a closed space formed by the rubber spring and the guide plate in the guide element.

In a specific implementation of this embodiment of the invention, in order to improve the stiffness and deformation of the rubber spring, the outer diameter of the metal inner ring body 6-2-1 is ⅓ to ⅔ of the diameter of the rubber spring 6-2, the thickness of the rubber outer ring body 6-2-3 is 1/10 to ⅓ of the diameter of the rubber spring, and the diameter of the rubber boss structure 6-2-2 is greater than or equal to 1/10 of the diameter of the rubber spring 6-2.

In a specific implementation of this embodiment of the invention, the fixing plate 11 is designed as a U-shaped clamp, and the fixing plate 11 and the protective net are clamped by a fixing cylinder. In other implementations of this embodiment of the invention, the fixing plate 11 may also be designed in other shapes, as long as it can be clamped on the protective net tightly.

### Embodiment 2

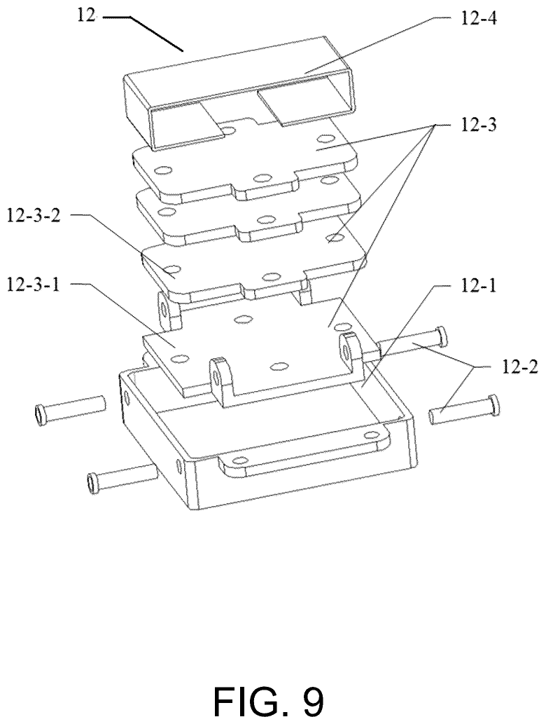

Based on Embodiment 1, this embodiment of the invention differs from Embodiment 1 in that: as shown in FIGS. 8-9, the vibration damping device further comprises a second vibration damping unit 12; the second vibration damping unit 12 comprises a fixed frame 12-1, a second elastic element 12-2, a combined mass block 12-3 and a covering 12-4;
the combined mass block 12-3 comprises a mass block holder 12-3-1 and a plurality of sub-mass blocks connected to the mass block holder 12-3-1;
the combined mass block 12-3 is installed in the fixed frame 12-1;
the second elastic element 12-2 is arranged between the fixed frame 12-1 and the combined mass block 12-3, has stiffness and damping properties, and has one to two directional degrees of freedom, the second elastic element has a frequency modulation ratio within a range of 0.85 to 0.95. In practice, the frequency modulation ratio of the second vibration damping unit 12 is changed mainly by adjusting the mass of the combined mass block 12-3, supplemented by adjusting the stiffness parameter of the second elastic element 12-2;
the combined mass block 12-3 is wrapped with the covering 12-4.

In a specific implementation, the second vibration damping unit 12 is also known as a seat dynamic vibration absorber, which is arranged on a framework of a seat back to eliminate vibrations of the seat in a direction vertical the seat back, or is fixed between the seat vibration-damping suspension and a seat cushion to eliminate vibrations of the seat in the up-down direction.

### Embodiment 3

The invention provides a cab, comprising the vibration damping device according to any one of Embodiment 1 and Embodiment 2.

### Embodiment 4

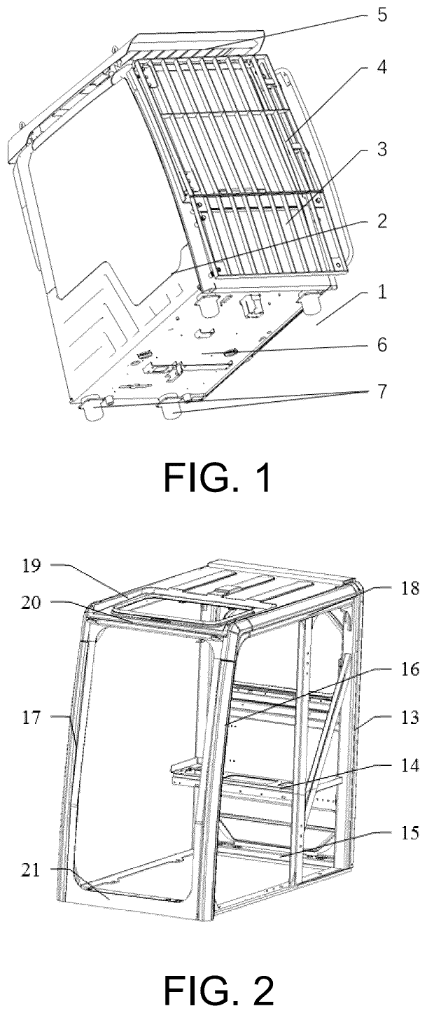

This embodiment of the invention provides a collaborative optimization method for the fatigue life and lightweight of a cab, comprising the following steps:
(1) using the plate thickness of elements to be optimized, in a cab body 2, that meet a preset condition as a key design variable;
(2) using the original plate thickness of the elements to be optimized that meet the preset condition before optimization and the minimum plate thickness of the elements reaching a fatigue life indicator to determine a feasible region; and
(3) taking the fatigue life of a cab assembly and the total weight of the cab assembly as goals of collaborative optimization and taking properties of the cab assembly after optimization being superior to or equal to those of the cab assembly before optimization as a constraint, performing interpolation within the feasible region to obtain an optimal combination of key design variables, wherein the cab assembly 1 comprises the cab body 2 and the vibration damping device 9 according to any one of claims 1-8, as shown in FIG. 1.

As shown in FIG. 2, the framework of the cab body 2 comprises a rear pillar 13, a seat support 14, a rear rectangular tube 15, a front left A-pillar profile 16, a front right A-pillar profile 17, a top left main framework profile 18, a top right main framework profile 19, a top rectangular tube 20, a front bottom plate rectangular tube 21. The cab body 2 also comprises a cab floor.

In a specific implementation of this embodiment of the invention, the step of using the plate thickness of the elements, in a cab body, that meet a preset condition as a key design variable comprises the following sub-steps:
obtaining preset elements to be optimized;
filtering elements to be optimized of which weight ratios to the total weight of the cab assembly are greater than a set threshold, and classifying elements to be optimized of which plate thickness difference is less than a set threshold into a group to form a plurality of combinations;
based on a finite element mesh model of the cab assembly before optimization, by reducing the plate thickness of the elements to be optimized in one combination, calculating the fatigue life corresponding to each combination under different plate thickness conditions, and further calculating the sensitivity of each combination to the fatigue life of the cab assembly; and
deleting combinations having a sensitivity greater than a set threshold, and using the plate thickness of the elements to be optimized in the remaining combinations as a key design variable.

In a specific implementation of this embodiment of the invention, the minimum plate thickness of the elements reaching the fatigue life indicator is obtained by the following step:
based on the finite element mesh model of the cab assembly before optimization, carrying out fatigue life simulation calculations to obtain the minimum plate thickness of the elements to be optimized in the remaining combinations when the elements meet the fatigue life requirement.

In a specific implementation of this embodiment of the invention, the step of taking the fatigue life of the cab assembly and the total weight of the cab assembly as goals of collaborative optimization, and taking properties of the cab assembly after optimization being superior to or equal to those of the cab assembly before optimization as a constraint, performing interpolation within the feasible region to obtain an optimal combination of key design variables comprises the following sub-steps:
taking a number of each combination and the plate thickness of the elements to be optimized in each combination as two-dimensional coordinates of the feasible region, and performing interpolation within the feasible region using a preset interpolation method to obtain a plurality of schemes, wherein each scheme is expressed as: (the number of the combination, the plate thickness of the elements to be optimized in the combination), and in a specific implementation, the interpolation method includes nearest neighbor interpolation or linear interpolation triangulation;
carrying out fatigue life simulation calculations for each optimization scheme, and based on results of the fatigue life simulation calculations, filtering combinations that reach the fatigue life indicator, as well as plate thickness corresponding to each of the combinations;
based on the filtered combinations and the plate thickness corresponding to each of the combinations, calculating the total weight of the cab assembly after optimization, and filtering a minimum total weight of the cab assembly, wherein the minimum total weight of the cab assembly is obtained by:

$$min f ( x ) = min \{ {f}_{I} ( x ) , {f}_{II} ( x ) , {f}_{III} ( x ) , {f}_{IV} ( x ) , {f}_{V} ( x ) , … , {f}_{k} ( x ) \} + {f}_{C}$$

$$x = {[ {x}_{I} , {x}_{II} , {x}_{III} , {x}_{IV} , {x}_{V} , … {x}_{k} ]}^{T}$$

where, x is the key design variable, x=[x_{I}, x_{II}, x_{III}, x_{IV}, x_{V}, . . . , xₖ]^{T} is variable space; I, II, III, IV, V . . . are the numbers of the filtered combinations; ƒ(x) is the total weight of the cab assembly after optimization; ƒₖ(x) is the weight of each filtered combination; ƒ_{c} is the remaining value of the total weight of the cab assembly minus the original mass of all the filtered elements to be optimized;
if a difference between the minimum total weight of the cab assembly after optimization and a target total weight of the cab assembly is less than a preset value, using the plate thickness corresponding to the filtered combination as an optimal combination.

In a specific implementation of this embodiment of the invention, prior to the step of taking a number of each combination and the plate thickness of the elements to be optimized in each combination as two-dimensional coordinates of the feasible region, the collaborative optimization method for the fatigue life and lightweight of a cab further comprises:
taking the number of each combination and the plate thickness of the elements to be optimized in each combination as two-dimensional coordinates of the feasible region to calculate the total weight of the cab assembly corresponding to each combination under different plate thickness conditions; and
based on the criteria that the calculated total weight of the cab assembly should be less than the target total weight of the cab assembly, excluding combinations that do not reach the criteria, as well as the plate thickness corresponding to the combinations.

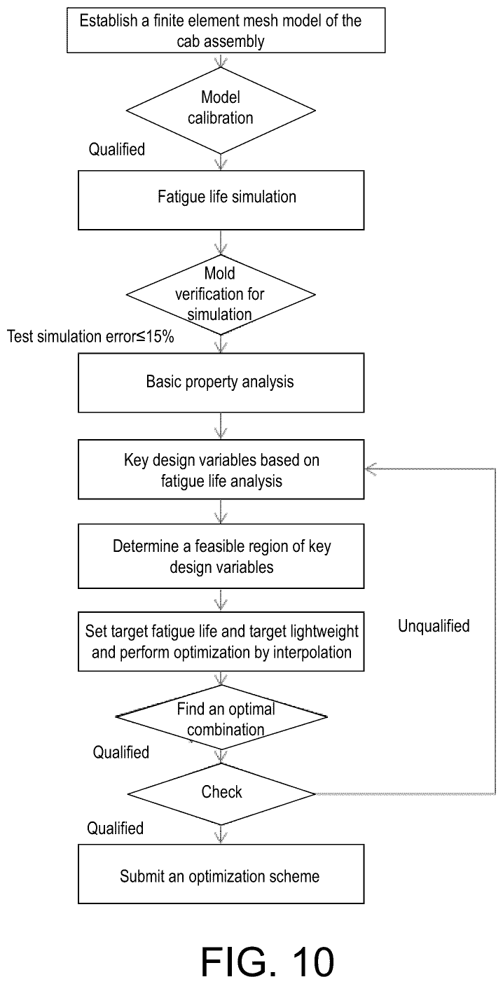

The collaborative optimization method in this embodiment of the invention will be described in detail below with reference to a specific implementation. The collaborative optimization design method, as shown in FIG. 10, specifically comprises the following steps:

Step 1: obtaining relevant parameters required for collaborative optimization

1) Establishing a finite element mesh model of the cab assembly, and checking the mesh quality of the finite element mesh model of the cab assembly

Mesh division is carried out on the three-dimensional CAD model of the cab assembly to generate the finite element mesh model of the cab assembly.

The mesh quality of the finite element mesh model of the cab assembly is checked, wherein the main parameters involved in the mesh quality need to meet the following conditions: the Jacobian ratio>0.5, the minimum angle of the triangular mesh>20°, and the minimum angle of the quadrilateral mesh>45°.

2) Carrying out calibration for the finite element mesh model of the cab assembly

Based on the finite element mesh model of the cab assembly, simulation calculations are carried out by a random vibration method to obtain the simulation values of modal vibration shape and modal frequency of the cab assembly.

The test values of modal vibration shape and frequency of the cab assembly are obtained by the free modal test of the cab assembly.

When the error between the simulation value and the test value of modal frequency is less than 10%, it is determined that the finite element mesh model of the cab assembly is applicable to fatigue life simulation and basic property simulation.

3) Obtaining the material properties of elements in the cab assembly to form a material library

The cab assembly generally comprises a main framework (which is welded from metal profiles, rectangular tubes and reinforcing ribs), covering parts, doors, windows, seats and other main elements. The main materials of the elements are different types of structural steel, tempered glass, adhesives, etc.

The main material properties of the materials of the elements, such as density, elastic model and Poisson's ratio, are obtained.

4) Obtaining the measured load spectrum of the cab assembly throughout the entire life cycle of the whole machine, and extracting a simulated load spectrum from the measured load spectrum of the cab assembly

At a user's construction site or test site, the load spectrum of the cab assembly, including vibration and stress signals, is acquired.

According to the design target life of the cab assembly and the proportion of each working condition in the entire life cycle, the load spectrum safety factor (generally 1-2) is set; based on the cumulative damage equivalent principle, the synthesis and equivalent compression of the time domain load spectrum of the cab assembly are completed, and the time domain six-degree-of-freedom vibration load spectrum of the cab assembly, i.e., the measured load spectrum of the cab assembly, is output.

Using virtual MAST software or virtual load iteration technology, the time domain six-degree-of-freedom vibration load spectrum of the cab assembly is converted into a time-domain six-degree-of-freedom force spectrum, which is used as the simulated load spectrum of the fatigue life of the cab assembly (i.e., extracting the simulated load spectrum from the measured load spectrum of the cab assembly).

The measured load spectrum of the cab assembly is applied to the cab assembly to obtain a measured vibration signal.

The simulated load spectrum is applied to the finite element mesh model of the cab assembly to generate a simulated vibration signal. The measured vibration signal is compared with the simulated vibration signal. When the iterative reproduction accuracy of the simulated vibration signal is greater than 85%, it is determined the simulated load spectrum is valid.

Step 2: carrying out the fatigue life simulation and basic property analysis of the cab assembly before optimization

5) Carrying out pre-processing for fatigue life simulation calculation and solver settings

The finite element mesh model of the cab assembly is imported.

The material properties of the elements of the cab assembly are mapped to the elements in the finite element mesh model of the cab assembly, that is, the solver is connected to the material library.

The input of the simulated load spectrum is defined and the simulated load spectrum is loaded to loading points in the finite element mesh model of the cab assembly.

The connection relationship between various elements in the finite element mesh model of the cab assembly is set. The connection relationship between various elements of the cab assembly includes welding, bolting, hinging, gluing and fixed connections. For example: the weld joint relationship between two elements is connection by shell units, and element 1 and element 2 share the same node with the weld joint. REB2 is used to simulate bolted connections. SEAM is used to simulate the connection of glass in close contact with plates.

An event processing method is set, with the fast superposition method or the complete superposition method being preferred. A stress combination method is set, with the critical surface method being preferred. A multi-axial stress assessment method is set, with the Auto method being preferred, in which the principal stress (Abs Max Principal) is used for standard evaluation in the first stage, and the combination method is adjusted in the second stage according to the results of the first stage, with the rain flow count being preferred to calculate the fatigue life. Stress gradient correction is set and then activated, the priority is given to using the FKM method to evaluate the influence of the stress gradient, and a specified stress gradient correction method is further selected to complete the design of the solver.

6) Carrying out vibration fatigue life simulation of the cab assembly before optimization and performing mold verification

Based on the set solver and finite element mesh model of the cab assembly, the time domain fatigue life simulation analysis of the cab assembly and post-processing are carried out by operations.

The mold verification is performed for the fatigue life simulation of the cab assembly. The bench test fatigue life results corresponding to the simulation are used to correct the simulation parameters (i.e., the parameters of the finite element mesh model of the cab assembly and the solver). The corrected simulation parameters include but are not limited to S-N curves, survival rates, and load spectrum safety factors of materials, etc. It should be ensured that the fatigue life simulation results of the cab assembly meet accuracy requirements. When the error between the fatigue life simulation results of the cab assembly and the bench test life is less than 15%, the fatigue life simulation results are determined to be valid and can be used for data analysis and simulation optimization.

7): carrying out basic property analysis of the cab assembly before optimization

Simulation and analysis calculations are carried out on key basic properties that affect the fatigue life of the cab assembly before optimization, including structural static strength, etc. Their indicators are used as constraints, and it is required that the above-mentioned basic property parameters of the cab assembly after optimization is not lower than their levels before optimization.

Step 3: setting goals of the collaborative optimization for the fatigue life and lightweight of the cab assembly, determining key design variables and feasible regions, and carrying out parameter optimization calculations

8) Setting initial design goals for the fatigue life and lightweight of cab assembly

Based on the fatigue life and total weight of the cab assembly before optimization, in combination with benchmark indicators and design experience, reasonable optimization goals are initially determined for the cab assembly.

9) Determining key design variables and their feasible regions

\textcircled{1} The optimization objects are set to the main framework of the cab body (welded from metal profiles, rectangular tubes and reinforcing ribs), coverings, doors, windows and other self-made parts, excluding outsourced parts such as air conditioning systems. It should be noted that the optimization objects in the embodiments of the invention include but are not limited to the cab floor, rear left and right pillars, front left and right A-pillars, top left and right main frameworks, rear cross beams (upper, middle and lower), seat supports, vehicle doors, various coverings, etc.

\textcircled{2} Within the scope of selected optimization objects, all elements of which the weight is greater than 2% of the total weight of the cab assembly, the elements with the same or similar plate thickness are classified into a group and then a plurality of combinations are obtained. The combinations are numbered as I, II, III, . . . .

\textcircled{3} On the simulation model of the cab assembly before optimization, the plate thickness of the elements to be optimized in one of the above combinations is reduced, and the fatigue life of the cab assembly is calculated. Sensitivity analysis is carried out between the fatigue life of the cab assembly and the plate thickness of the elements to be optimized in each combination, combinations with too high sensitivity are excluded from the scope of optimization objects, and the plate thickness of the elements to be optimized in the remaining combinations is used as the key design variable.

\textcircled{4} In the meanwhile, based on the finite element mesh model of the cab assembly before optimization, fatigue life simulation calculations are carried out to obtain the minimum plate thickness of the elements to be optimized in the remaining combinations when the elements meet the fatigue life requirement; by using the minimum plate thickness of the elements as the lower limit of the key design variable and their original plate thickness as the upper limit of the feasible region, the feasible region Q of the key design variable, i.e., the variable range of the plate thickness of elements in each combination, is determined.

10) Performing interpolation within the feasible region and carrying out scheme optimization calculations

\textcircled{1} Based on the criteria that the calculated total weight of the cab assembly should be less than the target total weight of the cab assembly, by taking the number of each combination and the plate thickness of the elements to be optimized in each combination as two-dimensional coordinates of the feasible region, the total weight of the cab assembly corresponding to each combination under different plate thickness conditions is calculated and combinations that do not reach the criteria, as well as the plate thickness corresponding to the combinations, are excluded.

\textcircled{2} By taking the number of each combination and the plate thickness of the elements to be optimized in each combination as two-dimensional coordinates of the feasible region, interpolation is performed within the feasible region using a preset interpolation method to obtain a plurality of schemes, wherein each scheme is expressed as: (the number of the combination, the plate thickness of the elements to be optimized in the combination).

Fatigue life simulation calculations are carried out for each optimization scheme, and based on results of the fatigue life simulation calculations, combinations that reach the fatigue life indicator and plate thickness corresponding to each combination are filtered.

\textcircled{3} Based on the filtered combinations and the plate thickness corresponding to each of the combinations, the total weight of the cab assembly after optimization is calculated and a minimum total weight of the cab assembly is filtered. The minimum total weight of the cab assembly is obtained by:

$$min f ( x ) = min \{ {f}_{I} ( x ) , {f}_{II} ( x ) , {f}_{III} ( x ) , {f}_{IV} ( x ) , {f}_{V} ( x ) , … , {f}_{k} ( x ) \} + {f}_{C}$$

$$x = {[ {x}_{I} , {x}_{II} , {x}_{III} , {x}_{IV} , {x}_{V} , … {x}_{k} ]}^{T}$$

where, x is the key design variable, x=[x_{I}, x_{II}, x_{III}, x_{IV}, x_{V}, . . . , xₖ]^{T} is variable space; I, II, III, IV, V . . . are the numbers of the filtered combinations; ƒ(x) is the total weight of the cab assembly after optimization; ƒₖ(x) is the weight of each filtered combination; ƒ_{c} is the remaining value of the total weight of the cab assembly minus the original mass of all the filtered elements to be optimized.

\textcircled{4} If a difference between the minimum total weight of the cab assembly after optimization and the target total weight of the cab assembly is less than a preset value, the plate thickness corresponding to the filtered combination is used as an optimal combination.

If it is determined that the requirement is met, the process proceeds to the next step.

If it is determined that the requirement is not met, the filtered combination and the plate thickness corresponding to the combination are found, an optimization range is set in its adjacent region to perform the second to third rounds of interpolation and calculations to find the optimal collaborative scheme for fatigue life and lightweight.

If the optimal scheme meets the requirement, the process proceeds to the next step.

If the requirement is not met, the process returns to step 8) to reset the optimization goals, determine the key design variables and their feasible regions, perform interpolation within the feasible regions and carry out optimization calculations.

Step 4: carrying out basic property check of the cab assembly after optimization

11) Carrying out basic property analysis of the cab assembly after optimization (including structural static strength simulation, etc.)

Simulation and analysis calculations are carried out on the key basic properties of the cab assembly after optimization, including structural static strength, etc. The analysis results are compared with the basic properties of the cab assembly before optimization. If it is determined that all basic property requirements are met, the process proceeds to the next step.

Otherwise, the process returns to step 8) to reset the optimization goals, determine the key design variables and their feasible regions, perform interpolation within the feasible regions and carry out optimization calculations.

Step 5: submitting a collaborative optimization scheme for the fatigue life and lightweight of the cab assembly

12) Submitting a collaborative optimization scheme, which includes the names and plate thicknesses of all elements to be optimized, and other element names and parameters, and providing a completed collaborative optimization simulation analysis report.

The above shows and describes the basic principles, main features and advantages of the invention. Those skilled in the industry should understand that the invention is not limited by the above-mentioned embodiments. The above-mentioned embodiments and description only illustrate the principles of the invention. Without departing from the spirit and scope of the invention, the invention will also have various changes and improvements, and these changes and improvements all fall within the scope of the invention. The scope of the invention is defined by the appended claims and their equivalents.

What is claimed is:

1. A vibration damping device for a cab, comprising a first vibration damping unit, wherein the first vibration damping unit comprises protective nets, a fixing plate, a base, a guide element, a first elastic element and a limiting element;
the fixing plate is arranged opposite to the base and connected to the protective nets;
the guide element is located between the fixing plate and the base and opposite to the base, a movement space is formed between the guide element and the base, and the base is also configured to be connected to a cab body;
the first elastic element is arranged in the movement space;
the limiting element has one end connected to the base and an other end working together with the fixing plate to limit a stroke of the first elastic element.

2. The vibration damping device for the cab according to claim 1, wherein the limiting element comprises a limiting cylinder and a limiting plate; the guide element comprises a guide rod and a guide plate;
the limiting cylinder has a first end connected to the base and a second end working together with the fixing plate to limit the stroke of the first elastic element;
the limiting plate is configured as an elastic body and is connected to the fixing plate, and the limiting plate is capable of reciprocating in the limiting cylinder;
the guide plate is arranged opposite to the base, and the movement space is formed between the guide plate and the base;
the guide rod has a third end connected to the base and a fourth end passing through the guide plate, the limiting plate and the fixing plate in sequence; the guide plate, the limiting plate and the fixing plate are capable of reciprocating along the guide rod.

3. The vibration damping device for the cab according to claim 2, wherein the first elastic element is configured as a spiral spring or a rubber spring;
the rubber spring comprises a metal inner ring body, a rubber outer ring body and a rubber boss structure;
the metal inner ring body is in a hollow structure;
the rubber outer ring body is arranged around the metal inner ring body and is connected to the metal inner ring body by the rubber boss structure.

4. The vibration damping device for the cab according to claim 3, wherein at one end of the rubber spring, an end portion of the rubber outer ring body is higher than an end portion of the rubber boss structure and an end portion of the metal inner ring body, and the end portion of the metal inner ring body is higher than the end portion of the rubber boss structure; at an other end of the rubber spring, the end portion of the metal inner ring body is higher than the end portion of the rubber outer ring body and the end portion of the rubber boss structure.

5. The vibration damping device for the cab according to claim 3, wherein an outer diameter of the metal inner ring body is ⅓ to ⅔ of a diameter of the rubber spring, a thickness of the rubber outer ring body is 1/10 to ⅓ of the diameter of the rubber spring, and a diameter of the rubber boss structure is greater than or equal to 1/10 of the diameter of the rubber spring.

6. The vibration damping device for the cab according to claim 3, wherein the first vibration damping unit further comprises a damping element which is a damping rod or a granular damping material; the granular damping material is arranged in a closed space formed between the rubber spring and the guide plate.

7. The vibration damping device for the cab according to claim 1, wherein the first vibration damping unit has a frequency modulation ratio within a range of 0.85 to 0.95.

8. The vibration damping device for the cab according to claim 1, further comprising a second vibration damping unit, wherein the second vibration damping unit comprises a fixed frame, a combined mass block and a second elastic element;
the combined mass block is installed in the fixed frame and comprises a mass block holder and a plurality of sub-mass blocks connected to the mass block holder; a number of the sub-mass blocks and a shape of the sub-mass blocks are determined by a frequency of vibrations to be eliminated;
the second elastic element is arranged between the fixed frame and the combined mass block, has stiffness and damping properties, and has two directional degrees of freedom.

9. The vibration damping device for the cab according to claim 8, wherein the second vibration damping unit has a frequency modulation ratio within a range of 0.90 to 0.97.

10. The cab comprising the vibration damping device according to claim 1.

11. A collaborative optimization method for a fatigue life and a lightweight of a cab, by comprising:
using a plate thickness of elements to be optimized, in a cab body, that meet a preset condition as a key design variable;
using an original plate thickness of the elements to be optimized that meet the preset condition before optimization and a minimum plate thickness of elements reaching a fatigue life indicator to determine a feasible region; and
taking a fatigue life of a cab assembly and a total weight of the cab assembly as goals of collaborative optimization and taking properties of the cab assembly after optimization being superior to or equal to properties of the cab assembly before optimization as a constraint, performing interpolation within the feasible region to obtain an optimal combination of the key design variable, wherein the cab assembly comprises the cab body and the vibration damping device according to claim 1.

12. The collaborative optimization method for the fatigue life and the lightweight of the cab according to claim 11, wherein a step of using the plate thickness of the elements to be optimized, in the cab body, that meet the preset condition as the key design variable comprises the following sub-steps:
obtaining preset elements to be optimized;
filtering elements to be optimized of which weight ratios to a total weight of the cab assembly are greater than a set threshold, and classifying the elements to be optimized of which plate thickness difference is less than the set threshold into a group to form a plurality of combinations;
based on a finite element mesh model of the cab assembly before optimization, by reducing the plate thickness of the elements to be optimized in one combination, calculating the fatigue life corresponding to each combination under different plate thickness conditions, and further calculating a sensitivity of the each combination to the fatigue life of the cab assembly; and
deleting combinations having a sensitivity greater than the set threshold, and using the plate thickness of the elements to be optimized in remaining combinations as the key design variable.

13. The collaborative optimization method for the fatigue life and the lightweight of the cab according to claim 11, wherein the minimum plate thickness of the elements reaching the fatigue life indicator is obtained by the following step:
based on the finite element mesh model of the cab assembly before optimization, carrying out fatigue life simulation calculations to obtain the minimum plate thickness of the elements to be optimized in the remaining combinations when the elements meet a fatigue life requirement.

14. The collaborative optimization method for the fatigue life and the lightweight of the cab according to claim 11, wherein the step of taking the fatigue life of the cab assembly and the total weight of the cab assembly as the goals of collaborative optimization and taking the properties of the cab assembly after optimization being superior to or equal to the properties of the cab assembly before optimization as the constraint, performing the interpolation within the feasible region to obtain the optimal combination of the key design variable comprises the following sub-steps:
taking a number of each combination and the plate thickness of the elements to be optimized in each combination as two-dimensional coordinates of the feasible region, and performing the interpolation within the feasible region using a preset interpolation method to obtain a plurality of schemes, wherein each scheme is expressed as: (the number of the each combination, the plate thickness of the elements to be optimized in the each combination);
carrying out fatigue life simulation calculations for each optimization scheme, and based on results of the fatigue life simulation calculations, filtering combinations that reach the fatigue life indicator, as well as plate thickness corresponding to each of the combinations;
based on filtered combinations and the plate thickness corresponding to each of the combinations, calculating the total weight of the cab assembly after optimization, and filtering a minimum total weight of the cab assembly; and
if a difference between the minimum total weight of the cab assembly after optimization and a target total weight of the cab assembly is less than a preset value, using the plate thickness corresponding to the filtered combination as an optimal combination.

15. The collaborative optimization method for the fatigue life and the lightweight of the cab according to claim 14, wherein the minimum total weight of the cab assembly is obtained by:
$$min f ( x ) = min \{ {f}_{I} ( x ) , {f}_{II} ( x ) , {f}_{III} ( x ) , {f}_{IV} ( x ) , {f}_{V} ( x ) , … , {f}_{k} ( x ) \} + {f}_{C}$$
$$x = {[ {x}_{I} , {x}_{II} , {x}_{III} , {x}_{IV} , {x}_{V} , … {x}_{k} ]}^{T}$$
where, x is the key design variable, x=[x_{I}, x_{II}, x_{III}, x_{IV}, x_{V}, . . . , xₖ]^{T} is variable space; I II, III, V . . . are the numbers of the filtered combinations; ƒ(x) is the total weight of the cab assembly after optimization; ƒₖ(x) is a weight of each filtered combination; ƒ_{c} is a remaining value of the total weight of the cab assembly minus an original mass of all filtered elements to be optimized.

16. The collaborative optimization method for the fatigue life and the lightweight of the cab according to claim 14, wherein prior to the step of taking the number of each combination and the plate thickness of the elements to be optimized in each combination as the two-dimensional coordinates of the feasible region, the collaborative optimization method for the fatigue life and the lightweight of the cab further comprises:
taking the number of each combination and the plate thickness of the elements to be optimized in each combination as the two-dimensional coordinates of the feasible region to calculate the total weight of the cab assembly corresponding to each combination under different plate thickness conditions; and
based on a criteria that the calculated total weight of the cab assembly should be less than the target total weight of the cab assembly, excluding combinations that do not reach the criteria, as well as the plate thickness corresponding to the combinations.
